(19) United States
(12) Patent Application Publication
(10) Pub. No.: US 2006/0055955 A1
(43) Pub. Date: Mar. 16, 2006

(54) Method of processing autoprint format of image taken by digital still camera and printer for printing the image

(75) Inventor: Tatsuyuki Takebayashi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/224,836

(22) Filed: Sep. 12, 2005

(30) Foreign Application Priority Data
Sep. 15, 2004 (JP) 2004-268153

(51) Int. Cl. G06F 3/12

(52) U.S. Cl. 358/1.13

(57) ABSTRACT

To provide a method of processing an autoprint format capable of improving the analysis of an autoprint format, which was necessary by the number of job sections, to reduce wasted time in the analysis, components of an autoprint format in which print-setting information of an image taken by a digital still camera is recorded is converted into individual structures, the individual structures are linked to one another, and then printing is performed.

### BACKGROUND OF THE INVENTION

1. Field of the Invention

The present invention relates to a method of processing an autoprint format of an image taken by a digital still camera and a printer for printing the image, and in particular, it relates to a method of processing an autoprint format suitable for improving autoprint format analysis, which was needed by a number corresponding to the number of job sections, and a printer for printing the image.

2. Description of the Related Art

The mainstream of recent photographing methods is shifting from a general photographing method by a silver-salt camera to a photographing method by a digital still camera (DSC). Since the DSC stores taken pictures (images) as digital information, the taken images can easily be edited by the DSC etc. For example, print setting and editing are possible: the number of sheets to be printed is increased because it is delivered to many persons, or a necessary part of an image taken from a far distant position is cut out and then printed on an enlarged scale. The functions of the DSC are infeasible in the conventional photographing method by the silver-salt camera. Thus the method of specifying printing an image by the DSC is different from the conventional method. In response to the needs for the specifying method, an autoprint format technique has been developed (refer to Nonpatent Document 1).

As shown in FIG. 3, the autoprint format includes, as information on autoprint, an image-recorder information section (header [HDR] section) and an image-data print-setting information section (job [JOB] section). The header section includes information on the version of a DPOF specification to which the autoprint format conforms, the name of a product that has saved an autoprint file last, and creation date on which a file (hereinafter, referred to as an autoprint file) in which information in the autoprint format is recorded was saved last. Next to the header section, a job section is described. The job section generally includes multiple sections, each of which is sorted from one process to another. The contents described in the job section are information on a product ID indicative of a process number, a print type, such as standard printing and index printing, the quantity of sheets of the same contents to be printed, an image format, an the location of storage of image data and so forth. A printer analyzes the autoprint file including the information to allow designated contents to be automatically printed. The following is a related-art autoprint format processing for printing image data.

FIG. 4 is a flowchart for the related-art autoprint format processing. An autoprint file of the image data and a card recording medium that stores the image data are connected (S101).

After the connection is executed (S101), it is determined whether to read the autoprint file recorded in the recording medium (S102). When the determination is No (S102), the processing is finished; when the determination is Yes (S102), the header section in the autoprint file stored in the recording medium is analyzed (S103).

After the analysis of the header section (S103) is finished, the analysis of job sections recorded next to the header section is started from the first recorded job section (hereinafter, referred to as a first job section). The analysis of the job section (S104) is executed for each job section. When the analysis from the first job section to a single job section that has not yet been printed is finished, the analysis of the job section (S104) is completed even when unprinted job sections that is recorded following the “single job section that has not yet been printed” has not yet been analyzed. From the information on the header section that is acquired in the analysis (S103) and the information on the job section that is acquired in the analysis (S104), an object file is created which has a queue structure in which the information is optimized in data access performance (S105).

As shown in FIG. 5, for example, assuming that the first job section and the second job section for an autoprint file 111 have already been printed, and the third and later job sections have not been printed, the first job section and the second job section that have already been printed are analyzed again in the job-section analysis of S104, and then the unprinted third job section is analyzed. The job-section analysis of S104 is finished after completion of the analysis up to the third job section without analyzing the fourth job section. Then an object file 112 is created from the information on the header section acquired in the header-section analysis S103 and the information on the third job section acquired in the job-section analysis S104.

As shown in FIG. 4, after the creation of the object file 112 is completed (S105), the object file 112 is temporarily stored in the buffer of the printer (S106), and the printing of image data on an unanalyzed job section is started according to the instruction of the object file 112 stored in the buffer (S107).

After completion of printing process (S107), the printer determines whether an unprinted job section is present in the autoprint file 111 (S108). When there is an unprinted job section left, the procedure returns to the analysis of the header section (S103). When all the job sections are printed, the processing of the autoprint format ends (refer to Patent Document 1).

After analysis of the unprinted single job section, the process of printing must be undergone without shifting to the analysis of the following job section. This is because if all the job sections are analyzed and then individual object files are created, the total size of the individual object files may exceed the size of the memory of the buffer in the printer. If the total size of the object files exceeds the memory size of the buffer, the storage region of the buffer overflows (buffer overflow), causing an unexpected action.

Accordingly, in the related-art autoprint format processing method, print information acquired by unprinted single job section is converted to a single object file, and then printing is executed immediately according to the instruction of the object file without shifting to the analysis of the following job section.

[Patent Document 1] Japanese Unexamined Patent Application Publication No. 11-127323

[Nonpatent document 1] Canon Inc. and other three companies, “Digital Print Order Format (DPOF)” Specification, Version 1.10 <Part 1>, Matsushita Electric Industrial. Co., Ltd., Jul. 17, 2000, pp. 30-33, pp. 71-76

However, unless the job sections for the autoprint file are analyzed from the beginning again, the job sections following the printed job section cannot be printed. This posing the problem of necessity of autoprint file analysis by the number of the job sections of the autoprint file. The time required for the analysis varies depending on the size and number of job sections. For example, assuming that there are N job sections of the same size, the time required for printing all the job sections of the autoprint file is obtained by multiplying the time for analyzing and processing one job section by N!/N. In addition, the related-art processing method needs analysis of job sections that have already been printed, thus having the necessity of such inefficient analysis until all the job sections are printed.

### SUMMARY OF THE INVENTION

The present invention has been made in light of such circumstances, and has as an object the provision of an autoprint-format processing method capable of improving the analysis of an autoprint format that was needed by the number of job sections to print an image taken by a digital still camera, thereby reducing unnecessary time in analysis.

In order to achieve the object, according to a first aspect of the invention, a method of processing an autoprint format is provided which includes the step of converting components of an autoprint format in which print-setting information of a photographed image is recorded into individual structures, the step of linking the individual structures to one another, and the step of executing printing. This can reduce the number of times of analyses of the autoprint format, which was necessary by the number of job sections, to only one.

According to a second aspect of the invention, there is provided a printer including storage means in which the method of processing an autoprint format is stored.

The invention can reduce the time required for analysis for printing by reducing the number of analyses of an autoprint format, which was necessary by the number of job sections, to only one, thus offering a great advantage of significantly reducing accumulated printing time.

### BRIEF DESCRIPTION OF THE DRAWINGS

FIG. 1 is a flowchart for a method of processing autoprint format according to an embodiment of the invention;

FIG. 2 is a conceptual diagram illustrating the method of batch processing of an autoprint format, according to an embodiment of the invention;

FIG. 3 is a diagram of an example of the contents of an autoprint format;

FIG. 4 is a flowchart for a related-art method of processing an autoprint format; and

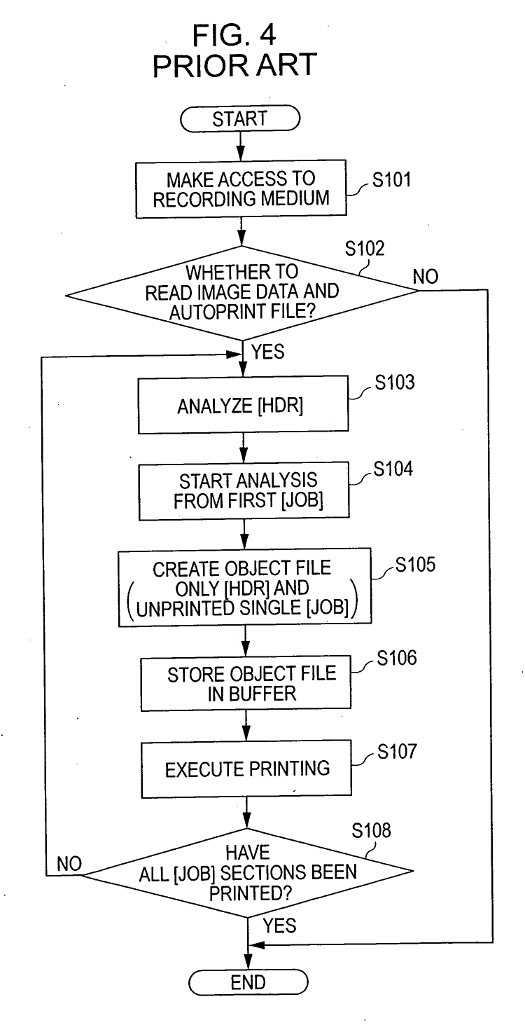

FIG. 5 is a conceptual diagram illustrating the related-art method of processing an autoprint format for each item of set information.

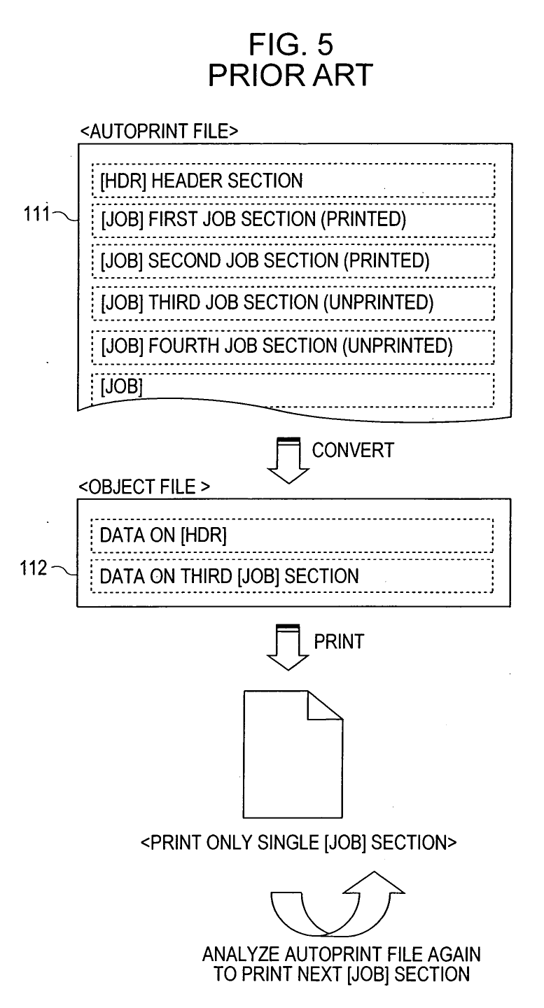

### DESCRIPTION OF THE PREFERRED EMBODIMENTS

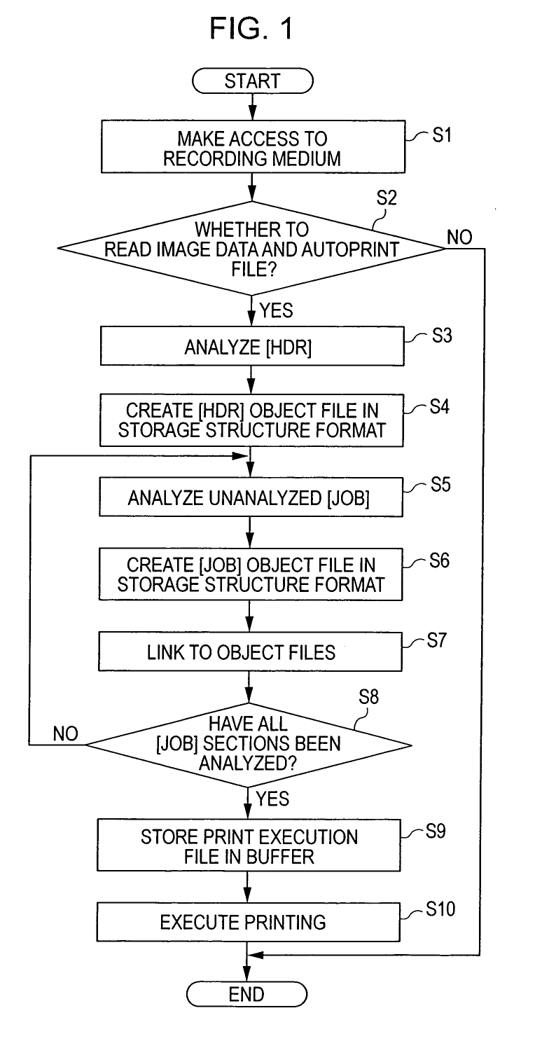

A method of processing an autoprint format according to an embodiment of the invention will be described with reference to FIGS. 1 to 3.

FIG. 1 is a flowchart for a method of processing an autoprint format according to an embodiment of the invention.

The processing method of the invention starts from the connection between an [autoprint.mrk] file (hereinafter, referred to as an autoprint file) that stores contents on an autoprint format and an external recording medium that stores image data (S1). As the external recording medium, it is preferable to use a memory card provided in a digital still camera (DSC). However, there is no need to limit the recording medium only if it can record an autoprint file and image data. The method of accessing an external recording medium (hereinafter, referred to as a memory card) is preferably a method of accessing a memory card by direct connection between a DSC including a memory card and a unit that can execute the processing method of the invention by a USB cable and a method of accessing a memory card via a reader such as a memory card reader provided to a unit that can execute the processing method of the invention, because they are general.

After a determination is made by access to the external recording medium whether image data and an autoprint file are present (S1), it is selected whether to read (access) the image data and the autoprint file (S2). When the reading is permitted, then the analysis of [HDR] (hereinafter, referred to as a header section) (S3) is started; when the reading is not permitted, the process of the invention ends.

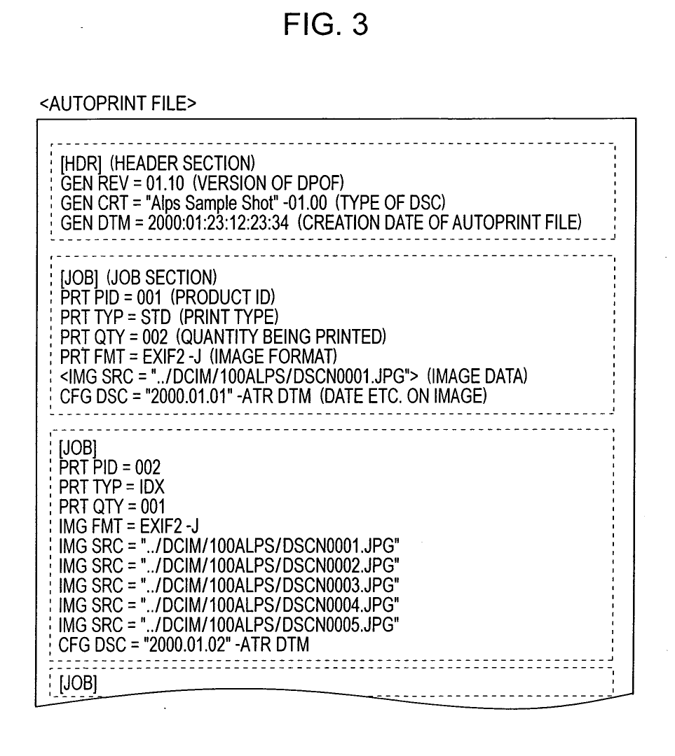

When the reading of the image data and the autoprint file is permitted (S2), then the analysis of [HDR] that is part the contents of the autoprint file, shown in FIG. 3, is started (S3). The analysis of [HDR] (S3) gives information on the version of the DPOF specification to which the autoprint format conforms and the type of the DSC. Refer to Nonpatent Document 1, because details of the header section and [JOB] (hereinafter, referred to as a job section) are described in it.

After completion of the analysis of the header section (S3), creation of a header-section object file having a storage structure format is started on the basis of the contents of the analyzed header section (S4). The structure is a system by which various data variables and arrays can be dealt with collectively. Specifically, the storage structure is a structure in which the contents of the autoprint file written in programming language is translated into low-level language and is decreased in capacity as appropriate for storage. The header-section object file can be linked to a job-section object file, to be described later.

After completion of the creation of the header-section object file (S4), then the analysis of an unanalyzed job section is started (S5). Any number of job sections are present between 1 and 999. For example, as shown in FIG. 3, the first job section from the top (a first job section) contains a series of print information from a product ID to the date of the image as one job section. The following job sections are segmented in this manner. The analysis S5 starts from the first job section.

After completion of the analysis of the first job section (S5), creation of a first-job-section object file having a storage structure format is started on the basis of the contents of the analyzed first job section (S6).

The created first-job-section object file allows exchange of print-setting information necessary for the printing S10, to be described later, by being linked to the header-section object file obtained by the creation step S4.

After completion of the linkage between the header-section object file and the first-job-section object file (S7), it is automatically determined whether the analysis of all the job sections in the autoprint file has been completed. When the analysis of the job sections have not been completed, the analysis of remaining job sections is started (S5).

In contrast to the related-art processing method, the processing method of the invention does not need to read and analyze the autoprint file again from the header section that is the first section, allowing starting the analysis along with the access to the autoprint file to execute the analysis immediately from a job section following the analyzed job section. Specifically speaking, by the related-art processing method, in order to print the second job section after completion of the printing up to the first job section, the analysis of the second job section is not started until access to the autoprint file is made and then the header section and the printed first job section are analyzed. On the other hand, by the method of the invention, upon completion of the analysis of the first job section, the analysis of the second job section can be started immediately without printing the first job section. The analysis method of the invention eliminates the necessity of duplication of analysis that has been necessary and access necessary for obtaining the autoprint file, reducing the time required for analysis. The reduction of operations including access to the file and so forth decreases the load on the CPU. This increases the processing speed (throughput) of printing itself. The larger the number of job sections, the larger the difference between the throughput by the related-art method and that by the method of the invention is.

The procedure from the analysis of the job sections (S5) to the determination on the completion of the analysis (S8) is repeated until the analysis of all the job sections is completed. After completion of the analysis of all the job sections, a print execution file created by linkage of the job sections is stored in the buffer (S9), and printing is started (S10).

By the completion of printing step S10, failure in the analysis of the autoprint file, and cancellation of reading of the image data and the autoprint file, the processing by the autoprint format ends.

### EMBODIMENT

The processing method of the invention is stored in a ROM built in the printer, as part of a program.

The printer includes, in addition to the ROM, a CPU that executes the processings, a buffer that stores the descriptions of processings, a USB port that allows connection to a recording medium and so forth. It is preferable to have an image display unit, an input key, and a memory card reader for facilitating settings.

The printer may adopt various printing systems, because the printing system has no direct connection with execution of the invention. The embodiment adopts a thermal sublimation printing system because it prints pictures according to the invention.

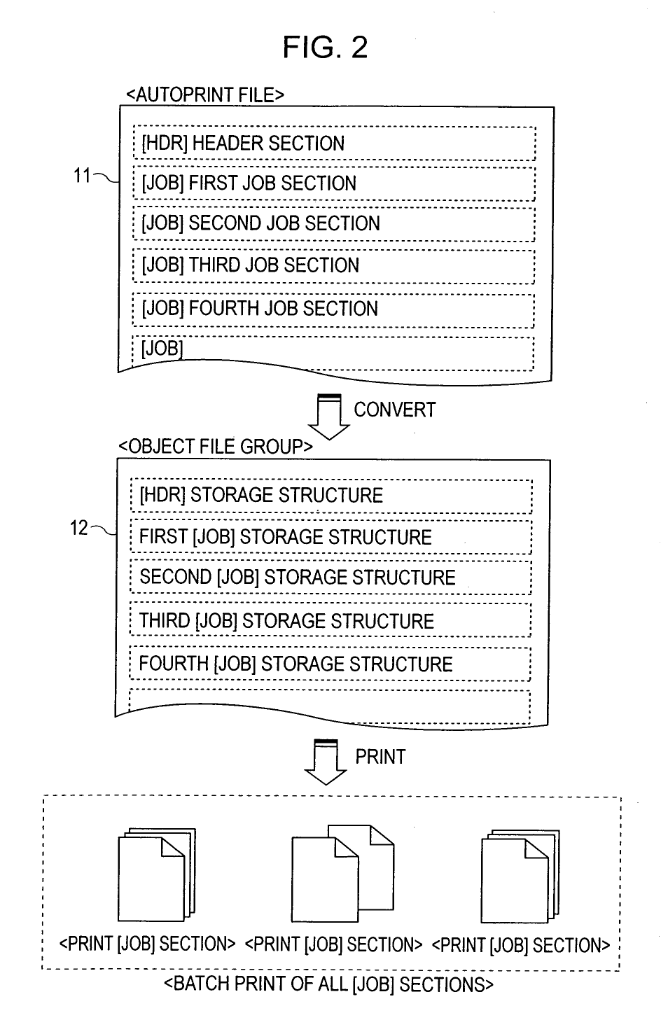

A printer that adopts the processing method of the invention (hereinafter, referred to as a printer) starts the analysis of an autoprint file 11, shown in FIG. 2, in such a way that it connects a DSC and the printer by a USB cable to access a memory card included in the DSC.

The printer having access to the autoprint file 11 converts (compiles) the header section and the multiple job sections to respective object files 12. Since the object files 12 are each in the form of a storage structure, they are compiled into one execution program, shown in FIG. 2, on the condition that the header section and the job sections are linked to one another.

All the object files 12 created are stored in the buffer and printing is executed according to the linked object files 12.

In contrast to the related-art processing method, the invention starts the printing after all the job sections have been analyzed. This does not cause pulse-like printing in which the analysis of the autoprint file is interposed between the printing steps, allowing continuous printing. Also, this eliminates the duplication of analysis to ensure throughput faster than ever. Accordingly, the time required from the start of the analysis to the end of the printing is significantly reduced.

It is to be understood that the invention is not limited to the foregoing embodiment but various modifications may be made as necessary.

What is claimed is:

1. A method of processing an autoprint format, comprising:
converting components of an autoprint format in which print-setting information of an image taken by a digital still camera is recorded into individual structures;
linking the individual structures to one another; and
executing printing.

2. A printer comprising storage means in which the method of processing an autoprint format according to claim 1 is stored.
